(19) United States
(12) Patent Application Publication
(10) Pub. No.: US 2005/0035336 A1
(43) Pub. Date: Feb. 17, 2005

(54) Near infrared ray absorption composition and near infrared ray absorption filter

(76) Inventor: Shin Kuwabara, Aichi (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/883,920

(22) Filed: Jul. 6, 2004

(30) Foreign Application Priority Data
Aug. 1, 2003 (JP) 285287/2003

(51) Int. Cl. G02B 5/22

(52) U.S. Cl. 252/587

(57) ABSTRACT

There is provided a near infrared ray absorption composition which is well suited for use as a near infrared ray absorption filter particularly for a plasma display panel, since the composition is high in transmittance for visible rays, particularly blue ray transmittance and absorption efficiency for near infrared rays and besides, is excellent in long-term durability. The composition comprises a transparent resin; at least one dithiol nickel compound represented by the formula (1) 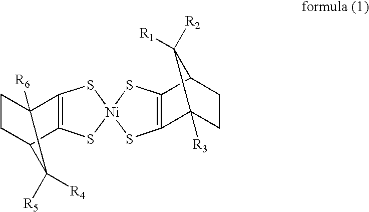
wherein R₁ to R₆ are each a hydrogen atom or an alkyl group having 1 to 8 carbon atoms, and may be the same or different; and/or at least one diimmonium compound represented by the formula (2) 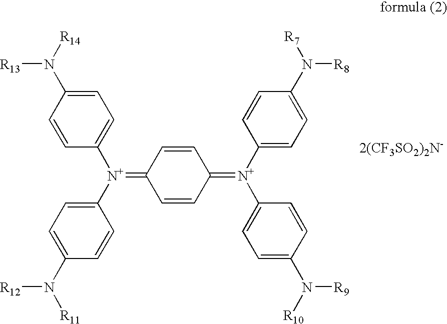
wherein R₇ to R₁₄ are each a hydrogen atom or an alkyl group having 1 to 8 carbon atoms or an aryl group having 6 to 24 carbon atoms, and may be the same or different.

### TECHNICAL FIELD

The present invention relates to a near infrared ray absorption composition well suited for use as a near infrared ray absorption filter which absorbs near infrared rays emitted from, for instance, a variety of display units, in particular absorbs rays having the wave range of 800 to 1000 nm, and which prevents erroneous action of peripheral electronic machines and instruments. More particularly, it pertains to a near infrared ray absorption composition which is well suited for use as a near infrared ray absorption filter, in particular for a plasma display panel, since the composition has a high transmittance for visible rays, has a high cutting efficiency for near infrared rays, and which imposes little load on the environment because of its being free from antimony.

### BACKGROUND ART

In recent years, various types of display units have been developed and commercialized as a large sized display unit. A plasma display, which is one of them, emits near infrared rays upon plasma discharge as is clear from the principle thereof. The wavelength of this near infrared rays, which is close to the wavelength of those that are used in remote control systems for electronic machines and instruments such as domestic TV set, cooler, video deck and the like, brings about a problem of inducing erroneous action of electronic machines and instruments in the case where any of the same lies in the vicinity of the plasma display.

In such circumstances, proposals have been made on the utilization of a filter which absorbs and shields near infrared rays, particularly the rays having the wave range of 800 to 1000 nm. Such filter is exemplified by (1) a filter made of phosphate glass containing bivalent copper ions, (2) a filter in which a thin layer of a metal, for instance, silver is formed on the surfaces of glass by vapor deposition method, sputtering method, ion plating method or the like and (3) a filter in which coloring matter which absorbs rays in near infrared wave range is blended in a resin.

However, among the above-mentioned filters, (1) involves the problem of hygroscopicity and intricate production process and (2) involves the problem that it reflect rays in visible ray region, although less than near infrared rays, that an excessive thickness reduces transmittance and that production cost is high.

On the contrary, (3) is highly advantageous in that it can be produced with less number of production steps as compared with (1) and (2) and can selectively absorb desirable wavelength rays by the combination of coloring matter.

As the above-mentioned infrared ray absorption coloring matter, a diazo base coloring matter is known, however it has low durability to heat, and thus is unsuitable for plasma display panel in which the surface temperature is as high as 60 to 90° C. by heat emission.

Moreover proposals have been made on the use of immonium base coloring matter (refer to Patent Literature 1). Among such coloring matter, usually use is made of the same having hexafluorinated antimony anion, and antimony as a violent poison exerts marked load on the environment which is public serious concern at the present time.

On the contrary, a dithiol metal compound as infrared ray absorption coloring matter absorbs little rays in visible ray region as compared with other coloring matter and is advantageous for display, whereby the practical use thereof is proposed (refer to Patent Literature 2 and 3).

Nevertheless, the dithiol metal compounds of the structure as described in Patent Literature 3 and 4 have high absorption at around 400 to 450 nm (low transmittance), and thus hinder blue light emission to which importance is attached particularly in display (refer to Comparative Example 1 and FIG. 4).

Patent Literature 1: Japanese Patent Application Laid-Open No. 27371/1996 (Heisei 8).

Patent Literature 2: Japanese Patent Application Laid-Open No. 230134/1997 (Heisei 9).

Patent Literature 3: Japanese Patent Application Laid-Open No. 62620/1998 (Heisei 10).

The present invention has been intended for providing a near infrared ray absorption composition which eliminates the troubles and difficulties of the above-mentioned prior arts, absorbs for instance, near infrared rays discharged from a display unit, is well suited for use as a near infrared ray absorption filter which prevents erroneous action of peripheral electronic machines and instruments, particularly for a plasma display panel, since the composition has a high transmittance for visible ray, has a high cutting efficiency for near infrared rays, and is excellent in long term weather resistance, and which imposes little load on the environment because of its being free from antimony.

### DISCLOSURE OF THE INVENTION

As a result of intensive extensive research and investigation accumulated by the present inventors in order to solve the above-mentioned subject, it has been found that the subject can be solved by blending a specific dithiol nickel compound and/or a specific diimmonium compound. Thus the present invention has been accomplished on the basis of the foregoing findings and information.

That is to say, the present invention provides a near infrared ray absorption composition which comprises a transparent resin; at least one dithiol nickel compound represented by the formula (1) 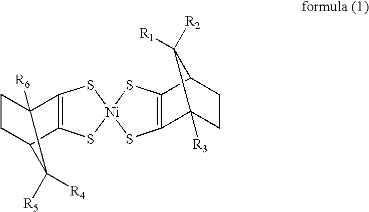
wherein R₁ to R₆ are each a hydrogen atom or an alkyl group having 1 to 8 carbon atoms, and may be the same as or different from one another; and/or at least one diimmonium compound represented by the formula (2) 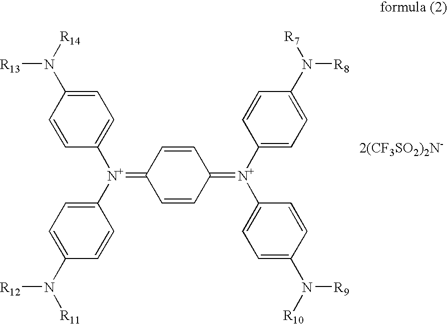
wherein R₇ to R₁₄ are each a hydrogen atom or an alkyl group having 1 to 8 carbon atoms or an aryl group having 6 to 24 carbon atoms, and may be the same as or different from one another, said transparent resin being blended with the compound (1) and/or the compound (2). The present invention also provides a near infrared ray absorption filter wherein a layer comprising the aforesaid near infrared ray absorption composition is formed on either surface of a transparent substrate.

### BRIEF DESCRIPTION OF DRAWING

FIG. 1 is a spectroscopic spectrum of the near infrared ray absorption film obtained in Example 1;

FIG. 2 is a spectroscopic spectrum of the near infrared ray absorption film obtained in Example 2;

FIG. 3 is a spectroscopic spectrum of the near infrared ray absorption film obtained in Example 3;

FIG. 4 is spectroscopic spectra of the near infrared ray absorption films obtained in Example 4 and Comparative Example 1;

FIG. 5 is a spectroscopic spectrum of the near infrared ray absorption film obtained in Example 5;

FIG. 6 is a spectroscopic spectrum of the near infrared ray absorption film obtained in Example 6;

FIG. 7 is a spectroscopic spectrum of the laminate film (AR/NIR film) obtained in Example 7;

FIG. 8 is spectroscopic spectrum of the near infrared ray absorption film obtained in Example 8.

FIG. 9 is a spectroscopic spectrum of the near infrared ray absorption film obtained in Example 9;

FIG. 10 is a spectroscopic spectrum of the near infrared ray absorption film obtained in Example 10;

FIG. 11 is a spectroscopic spectrum of the laminate film (AR/NIR film) obtained in Example 11;

FIG. 12 is a spectroscopic spectrum of the near infrared ray absorption film obtained in Example 12;

FIG. 13 is a spectroscopic spectrum of the laminate film (AR/NIR film) obtained in Comparative Example 2;

FIG. 14 is spectroscopic spectrum of the near infrared ray absorption film obtained in Comparative Example 3.

### THE MOST PREFERRED EMBODIMENT TO CARRY OUT THE INVENTION

In the following, the present invention will be described in more detail.

The above-mentioned transparent resin is that having a role of a binding resin. Preferable transparent resin, which is not specifically limited, is exemplified for excellent transparency, by at least one of the resins of polycarbonate base, polyarylate base, polyester base, norbornene base and methacrylic base and blended resin obtained therefrom.

As the dithiol nickel compound represented by the aforesaid formula (1), the compound in which R₁ to R₆ are all a methyl group represented by the under-mentioned formula (5) is preferable from the viewpoint of solubility in a solvent, stability against heat and transmission properties for RGB rays (particularly blue ray)

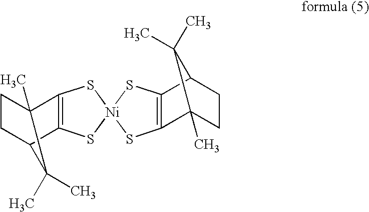

As the diimmonium compound represented by the aforesaid formula (2), the compound in which R7 to R14 are all an alkyl group having 1 to 8 carbon atoms, and same as or different from one another is preferable from the aspect of availability. In particular, the compound represented by the under-mentioned formula (6) is preferable from the viewpoint of solubility in a solvent, stability against heat and transmission properties for RGB rays (particularly blue ray).

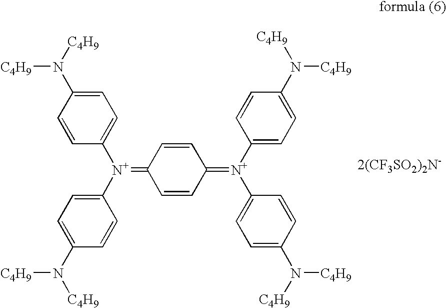

It is possible to most efficiently shield near infrared rays having wavelength of about 1000 nm which is most difficult to absorb by virtue of a near infrared ray absorption filter equipped with a near infrared ray absorption layer wherein use is made of as the coloring matter, the dithiol nickel compound represented by the aforesaid formula (1) and/or diimmonium compound represented by the aforesaid formula (2), and also possible to efficiently shield by using the coloring matter only, because the coloring matter has equally excellent absorption performance in the wave range of 900 to 1000 nm, near infrared rays having wave range of 850 to 1000 nm which is particularly needed as plasma display panel (PDP).

In particular, the simultaneous use of the dithiol nickel compound represented by the formula (1) and the diimmonium compound represented by the formula (2) is preferable in view of transmission for RGB rays in good balance and also a decrease in transmittance over the almost entire near infrared range.

Further, the dithiol nickel compound represented by the formula (1) and the diimmonium compound represented by the formula (2) are each excellent in absorption performance of near infrared rays per unit weight and besides, good in solubility in a variety of organic solvents.

Furthermore, the compounds represented by the formulae (5) and (6), respectively transmit blue ray emission to a great extent, and facilitate the regulation for RGB emission balance of a display.

The blending ratios of the dithiol nickel compound represented by the formula (1) and/or diimmonium compound represented by the formula (2) based on the above-mentioned transparent resin in the present invention are determined taking into consideration the thickness of the near infrared ray absorption filter and the absorption performance thereof in the case of producing the filter by the use of near infrared ray absorption composition. When the absorption performance is made constant, a thin near infrared ray absorption filter needs to blend in a large amount, whereas a thick filter needs not a large amount.

Specifically, the proper range of blending amount of the compounds is 0.05 to 800 mg, preferably 0.08 to 500 mg, more preferably 0.1 to 300 mg each per unit area, that is, one square meter (1 m²) of the near infrared ray absorption filter when the filter is completed.

The blending amount thereof, when being less than the above-mentioned range, sometimes brings about incapability of achieving the desirable absorption performance, whereas the blending amount, when being more than the range, sometimes causes decrease in transmittance for visible rays.

The near infrared ray absorption composition according to the present invention may be further blended with at least one dithiol nickel compound represented by the formula (3) to enhance the absorption performance in the wave range of 800 to 950 nm. 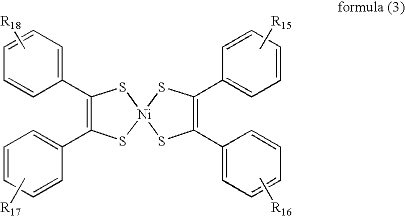
wherein R₁₅ to R₁₈ are each an alkyl group having 1 to 8 carbon atoms, an aryl group having 6 to 24 carbon atoms, an aralkyl group having 7 to 28 carbon atoms, an alkylamino group having 1 to 8 carbon atoms, an alkoxy group having 1 to 8 carbon atoms, a halogen atom or a hydrogen atom and are same as or different from one another.

The dithiol nickel compound represented by the formula (3) is exemplified by the compound represented by the formula (7) and the compound represented by the formula (8).

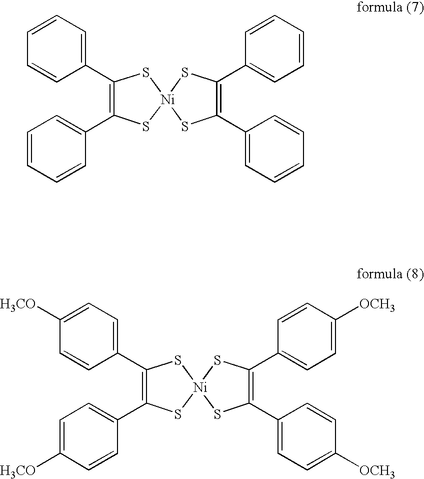

These compounds can enhance the absorption performance in the wave range of 800 to 950 nm without largely reducing the transmittance for visible rays.

The proper range of blending amount of the dithiol nickel compound represented by the formula (3) is 0.05 to 800 mg, preferably 0.08 to 500 mg, more preferably 0.1 to 300 mg per unit area, that is, one square meter of the near infrared ray absorption filter when the filter is completed,

The blending amount thereof, when being less than the above-mentioned range, sometimes brings about incapability of achieving the desirable absorption performance, whereas the blending amount, when being more than the range, sometimes causes decrease in transmittance for visible rays.

The near infrared ray absorption composition according to the present invention may be further blended with a dithiol nickel compound represented by the formula (4) to enhance the absorption performance in the wave range of 850 to 950 nm where the absorption performance of the above-mentioned compound alone is comparatively poor.

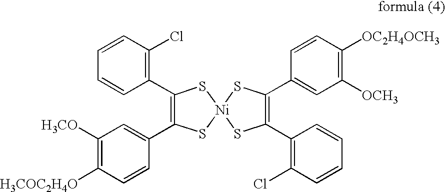

The proper range of blending amount of the dithiol nickel compound represented by the formula (4) is 0.001 to 800 mg, preferably 0.008 to 500 mg, more preferably 0.01 to 300 mg per unit area, that is, one square meter of the near infrared ray absorption filter when the filter is completed.

The blending amount thereof, when being less than the above-mentioned range, sometimes brings about incapability of achieving the desirable absorption performance, whereas the blending amount, when being more than the range, sometimes causes decrease in transmittance for visible rays.

The wavelength of around 575±20 nm includes yellowish green color rays to orange color rays, where with regard to plasma display in particular, there is strong emission of rays having a half width of about 10 nm and a peak of 595 nm assigned to enclosed Ne gas. Such emitted rays are usually unnecessary rays which hinders emission of red color rays.

The near infrared ray absorption composition according to the present invention may be further blended, in addition to the above-mentioned coloring matter, coloring matter which has absorption in the wave range of 580 to 600 nm and which is exemplified by porphyrin base coloring matter, cyanine base coloring matter and squalilium base coloring matter to enhance the intensity of red color by absorbing emitted rays of Ne in a plasma display. The coloring matter cuts not only the emitted light of Ne but also unnecessary rays in the wave range of around 580 to 600 nm, and thus reflection is minimized with a result that the contrast is improved.

The above-mentioned porphyrin base coloring matter is exemplified by the compound represented by the formula (9) 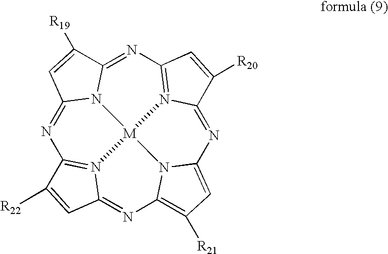
wherein R₁₉ to R₂₂ are each a hydrogen atom, an alkyl group having 1 to 12 carbon atoms, an aryl group having 6 to 12 carbon atoms, an alkenyl group having 2 to 18 carbon atoms, an aralkyl group having 7 to 14 carbon atoms, or an alkynyl group having 2 to 8 carbon atoms, and are same as or different from one another, and M is Fe, Ni, Sn, Zn or Cu.

Of these, the compound represented by the formula (10) is particularly preferable

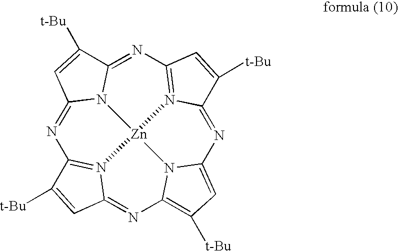

Without largely reducing the transmittance for visible rays and particularly in the case of a plasma display, without hindering red color emission, these compounds can enhance the intensity of red color by absorbing unnecessary light in the wave range of 575 to 595 nm.

The proper range of blending amount of the porphyrin base coloring matter is 0.001 to 800 mg, preferably 0.005 to 500 mg, more preferably 0.008 to 300 mg per unit area, that is, one square meter of the near infrared ray absorption filter when the filter is completed.

The blending amount thereof, when being less than the above-mentioned range, sometimes brings about incapability of achieving the desirable absorption performance, whereas the blending amount, when being more than the range, sometimes causes decrease in transmittance for visible rays.

The near infrared ray absorption composition according to the present invention may be further blended with ultraviolet absorbers, crosslinking agents, antioxidants, polymerization retardants, coloring matters, dyes, pigments and color adjusting agents, taking the type and the like of the transparent resin into consideration.

The near infrared ray absorption composition according to the present invention is produced only by adding the blending components to the transparent resin without specific limitation on the adding means. The components may be added in the form of a solution using a suitable solvent for the case where the composition is made into a near infrared ray absorption filmy filter by means of solution casting method.

The blending components need not be necessarily added simultaneously. The final near infrared ray absorption composition may be produced by preparing a resin solution incorporated with specific components, and adding the remaining components thereto.

Examples of the above-mentioned solvent include ether base solvent such as tetrahydrofuran (THF), diethyl ether, 1,4-dioxane and 1,3-dioxolane; ester base solvent such as ethyl acetate, methyl acetate and butyl acetate; alcohol base solvent such as methanol, ethanol and isopropyl alcohol; chlorine base solvent such as chloroform and methylene chloride; aprotic polar solvent such as dimethylformamide (DMF), dimethylsulfoxide (DMSO) and N-methylpyrrolidone (NMP), and ketone base solvent such as acetone and methyl ethyl ketone.

The near infrared ray absorption filter according to the present invention is composed of a transparent substrate and a near infrared ray absorption layer which comprises the above-mentioned near infrared ray absorption composition according to the present invention, and which is installed on either side of the substrate.

As a method for forming the near infrared ray absorption layer comprising the near infrared ray absorption composition, there is suitably used a method in which the near infrared ray absorption composition or a solution in a solvent is subjected to flow casting.

As the transparent substrate, there are preferably used a glass substrate and a transparent plastics substrate. The glass substrate is not specifically limited, but is exemplified by a glass plate such as soda glass, semi-reinforced glass and reinforced glass. Likewise, the transparent plastics substrate is not specifically limited, but is exemplified by a film, sheet, plate or the like composed of such plastics as acrylic resin, polycarbonate, polystyrene and methyl methacrylate/styrene copolymer.

As mentioned before, it is possible to impart ultraviolet ray (UV) cutting functions to the near infrared ray absorption layer by blending the near infrared ray absorption composition with a ultraviolet absorber, however, a transparent substrate imparted with UV cutting functions is also usable.

The thickness of the transparent substrate is not specifically limited, but is usually selected in the range of 0.05 to 5 mm.

An anti-reflection layer may further be installed at need on the near infrared ray absorption filter according to the present invention. In this case, an anti-reflection layer is located on the opposite side the near infrared ray absorption layer with respect to the transparent substrate.

Moreover, a UV cutting layer may be installed on either or both side of the transparent substrate instead of imparting ultraviolet ray UV cutting functions to the transparent substrate or to the near infrared ray absorption layer as mentioned above. In this case, when a near infrared ray absorption layer or an anti-reflection layer is formed on either or both side of the transparent substrate, it follows that the UV cutting layer is installed between the transparent substrate and any of the aforesaid two layers.

The near infrared ray absorption filter according to the present invention can be constituted as follows:
NIR layer/transparent substrate
NIR layer/transparent substrate with UV cutting functions
NIR layer/UV cutting layer/transparent substrate
NIR layer/transparent substrate with UV cutting functions/AR layer
NIR layer/UV cutting layer/transparent substrate/AR layer
NIR layer/transparent substrate/UV cutting layer
NIR layer/UV cutting layer/transparent substrate/UV cutting layer
NIR layer/transparent substrate/UV cutting layer/AR layer
NIR layer/UV cutting layer/transparent substrate/UV cutting layer/AR layer
   wherein NIR layer is a near infrared ray absorption layer, AR layer is anti-reflection layer, and an adhesive agent layer is inserted between each of the layers when necessary.

Means for imparting anti-reflection functions and/or UV cutting functions are not specifically limited, but may be selected for use from well known means.

The near infrared ray absorption filter according to the present invention can be preferably used in particular, for cathode ray tube, liquid crystal display, electroluminescence (EL) display, light emitting diode (LED) display, feed emission display (FED) and plasma display.

In what follows, the present invention will be described in more detail with reference to working examples.

### EXAMPLE 1

To 100 parts by weight of 1,3-dioxolane were added 21 parts by weight of polycarbonate resin (manufactured by Teijin Kasei Co., Ltd. under the trade name “Panlite L-1250Z-100”) and 0.85 part by weight of the immonium compound represented by the formula (6) (manufactured by Japan Carlit Co., Ltd. under the trade name “CIR-1085”) to prepare a solution.

The resin solution thus obtained was made into a film onto a polyester film having a thickness of 100 μm (micrometer) by means of solution casting method by the use of a bar coater having a clearance dimension of 100 μm (manufactured by Yoshimitsu Seiki Co., Ltd. under the trade name “Doctor Blade YD-2”, hereinafter the same being applied to working examples and comparative examples) and was dried at 80° C. for 3 minutes to obtain a film as a near infrared ray absorption filter.

The resultant film has a transmittance for blue rays (410 to 460 nm) as high as at least 70% compared with the Y value (85%), and is suited for a filter for display such as PDP.

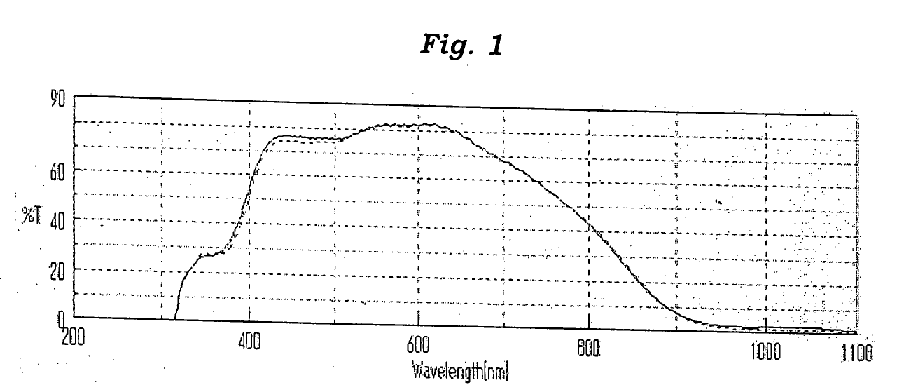

Further the resultant film was subjected to a heat resistance test at 90° C. for 1000 hours. The spectroscopic spectra before and after the heat resistance test are given in FIG. 1 wherein the solid line shows the spectrum before the heat resistance test, while the dotted line shows the spectrum after the test.

As can be clearly seen from the figure, the near infrared ray region of 850 to 1000 nm is sufficiently shielded and besides, the transmittance for visible rays is satisfactory.

Moreover, both the transmittance and the spectrum remained almost unchanged after 1000 hours of the heat resistance test. Accordingly the film has sufficient long-term heat resistance.

With regard to color shade, color change after the heat resistance test at 90° C. for 1000 hours was extremely low showing 0.0006 in terms of x and 0.0006 in terms of y, thereby proving little change in the color shade.

### EXAMPLE 2

To 100 parts by weight of 1,3-dioxolane were added 21 parts by weight of polycarbonate resin (manufactured by Teijin Kasei Co., Ltd. under the trade name “Panlite L-1250Z-100”) and 0.5 part by weight of the dithiol nickel compound represented by the formula (5) to prepare a solution.

In the same manner as in Example 1, from the resin solution thus obtained a film as a near infrared ray absorption filter was obtained.

The resultant film has a transmittance for blue rays (410 to 460 nm) as high as at least 85% compared with the Y value (87.5%), and is suited for a filter for display such as PDP.

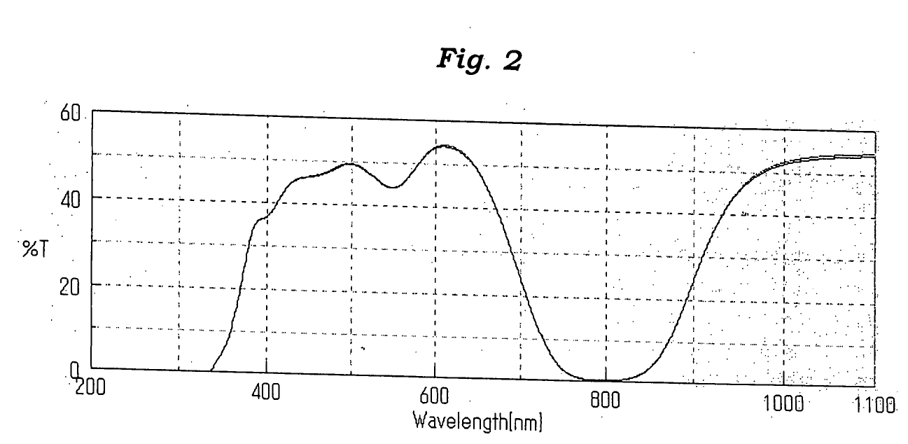

Further the resultant film was subjected to a heat resistance test at 90° C. for 1000 hours. The spectroscopic spectra before and after the heat resistance test are given in FIG. 2 wherein the solid line shows the spectrum before the heat resistance test, while the dotted line shows the spectrum after the test.

As can be clearly seen from the figure, the wavelength of 800 nm which gives rise to erroneous action on remote control and the like is sufficiently absorbed.

Moreover, both the transmittance and the spectrum remained almost unchanged after 1000 hours of the heat resistance test. Accordingly the film has sufficient long-term heat resistance.

With regard to color shade, color change after the heat resistance test at 90° C. for 1000 hours was extremely low showing 0.0004 in terms of x and 0.0006 in terms of y, thereby proving little change in the color shade.

### EXAMPLE 3

To 100 parts by weight of 1,3-dioxolane were added 21 parts by weight of polycarbonate resin (manufactured by Teijin Kasei Co., Ltd. under the trade name “Panlite L-1250Z-100”), 0.3 part by weight of the dithiol nickel compound represented by the formula (5) and 0.4 part by weight of the immonium compound represented by the formula (6) (manufactured by Japan Carlit Co., Ltd. under the trade name “CIR-1085”) to prepare a solution.

In the same manner as in Example 1, from the resultant resin solution, a film as a near infrared ray absorption filter was obtained.

The resultant film has a transmittance for blue rays (410 to 460 nm) as high as at least 70% compared with the Y value (70.00%), and is suited for a filter for display such as PDP.

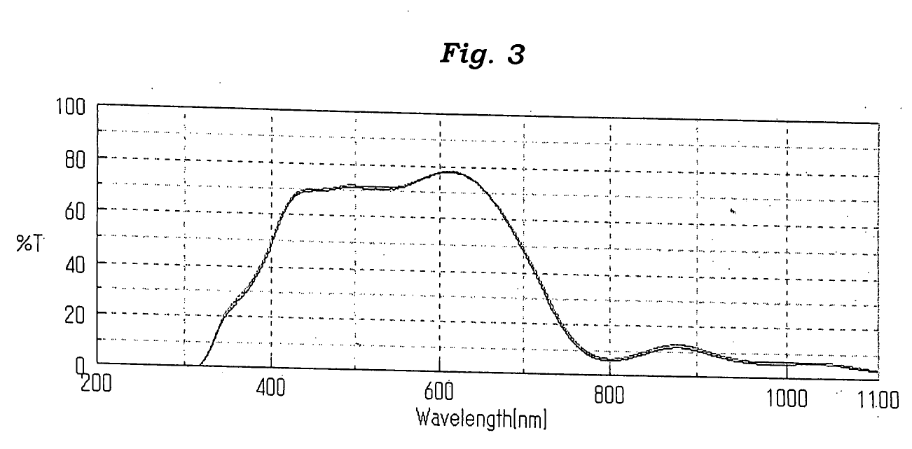

Further the resultant film was subjected to a heat resistance test at 90° C. for 1000 hours. The spectroscopic spectra before and after the heat resistance test are given in FIG. 3 wherein the solid line shows the spectrum before the heat resistance test, while the dotted line shows the spectrum after the test.

As can be clearly seen from the figure, the wave range of 800 to 1000 nm is sufficiently shielded and besides, the transmittance for visible rays is satisfactory.

Moreover, both the transmittance and the spectrum remained almost unchanged after 1000 hours of the heat resistance test. Accordingly the film has sufficient long-term heat resistance as a PDP filter.

With regard to color shade, color change after the heat resistance test at 90° C. for 1000 hours was extremely low showing 0.0004 in terms of x and 0.0009 in terms of y, thereby proving little change in the color shade.

### EXAMPLE 4

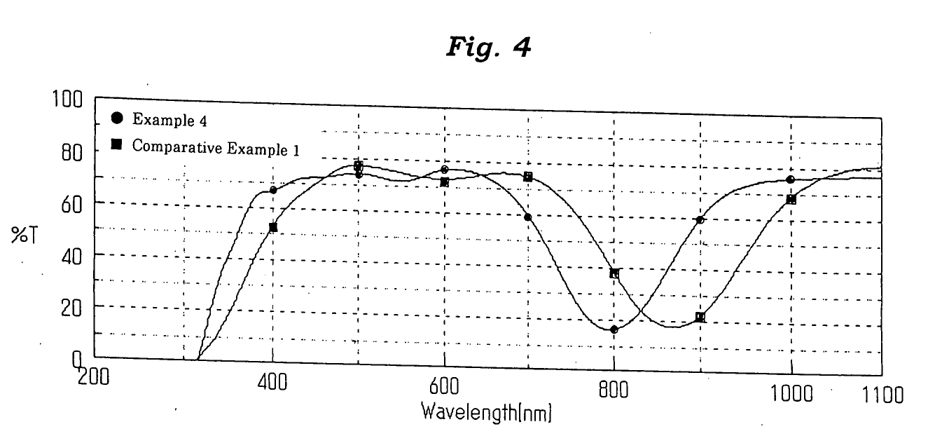

The procedure in Example 2 was repeated to obtain a film as a near infrared ray absorption filter except that the amount of 0.5 part by weight used of the dithiol nickel compound represented by the formula (5) was altered to 0.4 part by weight. The spectroscopic spectra are given in FIG. 4.

As can be clearly seen from the figure, the film has low absorption at 400 to 450 nm, that is, high transmittance for blue rays to which importance is attached in display such as PDP.

### COMPARATIVE EXAMPLE 1

The procedure in Example 4 was repeated to obtain a film as a near infrared ray absorption filter except that 0.4 part by weight of the dithiol nickel compound represented by the formula (5) was altered to 0.4 part by weight of the dithiol nickel compound represented by the formula (7) (manufactured by Midori Chemical Co., Ltd. under the trade name “MIR-101”). The spectroscopic spectra are given in FIG. 4.

As can be clearly seen from the figure, the film has high absorption at 400 to 450 nm, that is, low transmittance for blue rays to which importance is attached in display such as PDP.

### EXAMPLE 5

To 100 parts by weight of 1,3-dioxolane were added 21 parts by weight of polycarbonate resin (manufactured by Teijin Kasei Co., Ltd. under the trade name “Panlite L-1250Z-100”), 0.42 part by weight of the immonium compound represented by the formula (6) (manufactured by Japan Carlit Co., Ltd. under the trade name “CIR-1085”), 0.2 part by weight of the dithiol nickel compound represented by the formula (5), 0.12 part by weight of the dithiol nickel compound represented by the formula (7) (manufactured by Midori Chemical Co., Ltd. under the trade name “MIR-101”), 0.03 part by weight of the porphyrin compound represented by the formula (10) and 0.037 part by weight of a blue base coloring matter for color adjusting (manufactured by Japan Kayaku Co., Ltd. under the trade name “Kayaset Blue N”) to prepare a solution.

In the same manner as in Example 1, from the resultant resin solution, a film as a near infrared ray absorption filter was obtained.

The resultant film has a transmittance for blue rays (410 to 460 nm) as high as at least 60% compared with the Y value (53.6%), and is suited for a filter for display such as PDP.

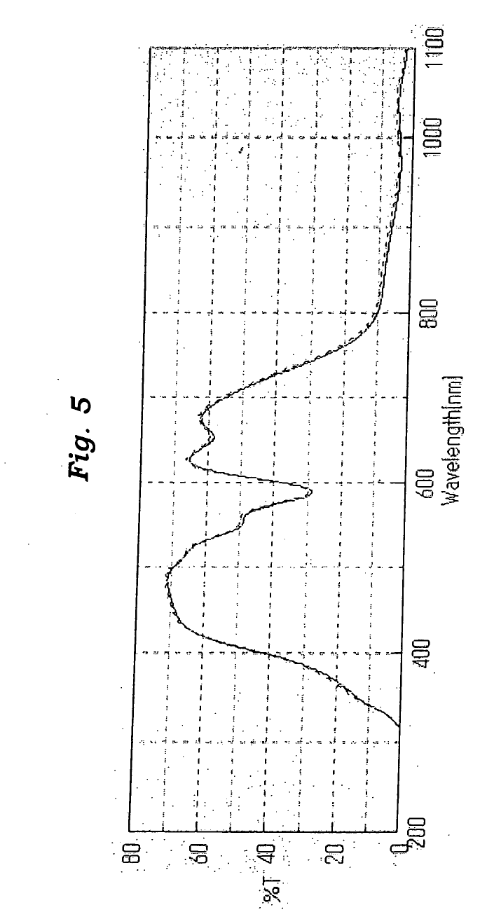

Further the resultant film was subjected to a heat resistance test at 90° C. for 1000 hours. The spectroscopic spectra before and after the heat resistance test are given in FIG. 5 wherein the solid line shows the spectrum before the heat resistance test, while the dotted line shows the spectrum after the test.

As can be clearly seen from the figure, the wave range of 850 to 1000 nm is sufficiently shielded and besides, the transmittance for visible rays is satisfactory.

Moreover, both the transmittance and the spectrum remained almost unchanged after 1000 hours of the heat resistance test. Accordingly the film has sufficient long-term heat resistance as a PDP filter.

With regard to color shade, color change after the heat resistance test at 90° C. for 1000 hours was extremely low showing 0.0007 in terms of x and 0.0005 in terms of y, thereby proving little change in the color shade.

### EXAMPLE 6

To 60 parts by weight of mixed solvent of toluene/methyl ethyl ketone at a ratio by volume of 1/1 were added 61 parts by weight of acrylic resin solution (manufactured by Japan Shokubai Kagaku Kogyo Co., Ltd. under the trade name “Hulshybrid IR-G204”), 0.4 part by weight of the immonium compound represented by the formula (6) (manufactured by Japan Carlit Co., Ltd. under the trade name “CIR-1085”), 0.24 part by weight of the dithiol nickel compound represented by the formula (7) (manufactured by Midori Chemical Co., Ltd. under the trade name “MIR-101”), 0.025 part by weight of the dithiol nickel compound represented by the formula (4) and 0.04 part by weight of the porphyrin compound represented by the formula (10) to prepare a solution.

In the same manner as in Example 1, from the resultant resin solution, a film as a near infrared ray absorption filter was obtained.

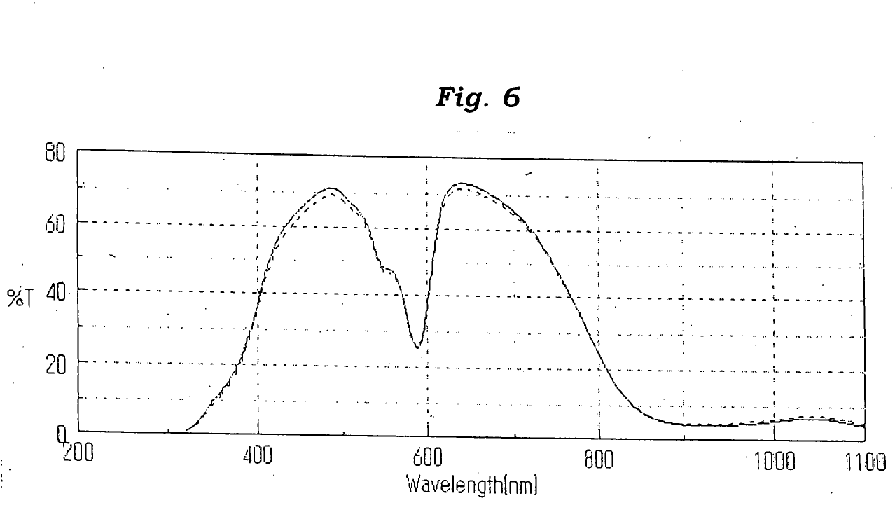

Further the resultant film was subjected to a heat resistance test at 90° C. for 1000 hours. The spectroscopic spectra before and after the heat resistance test are given in FIG. 6 wherein the solid line shows the spectrum before the heat resistance test, while the dotted line shows the spectrum after the test.

As can be clearly seen from the figure, the wave range of 850 to 1000 nm is sufficiently shielded and besides, the transmittance for visible rays is satisfactory.

Moreover, both the transmittance and the spectrum remained almost unchanged after 1000 hours of the heat resistance test. Accordingly the film has sufficient long-term heat resistance as a PDP filter.

With regard to color shade, color change after the heat resistance test at 90° C. for 1000 hours was extremely low showing 0.0008 in terms of x and 0.0004 in terms of y, thereby proving little change in the color shade.

### EXAMPLE 7

To 90 parts by weight of dichloromethane were added 20 parts by weight of polyethylene terephthalate resin (manufactured by Toyobo Co., Ltd. under the trade name “Bilon 270”), 0.4 part by weight of the immonium compound represented by the formula (6) (manufactured by Japan Carlit Co., Ltd. under the trade name “CIR-1085”), 0.24 part by weight of the dithiol nickel compound represented by the formula (7) (manufactured by Midori Chemical Co., Ltd. under the trade name “MIR-101”), 0.025 part by weight of the dithiol nickel compound represented by the formula (4) and 0.04 part by weight of the porphyrin compound represented by the formula (10) to prepare a solution.

In the same manner as in Example 1, from the resultant resin solution, a film as a near infrared ray absorption filter was obtained. The opposite side of the anti-reflection layer of the anti-reflection film (manufactured by Sumitomo Osaka Cement Co., Ltd. under the trade name “Clearas AR F210”) was laminated to the near infrared ray absorption side of the near infrared ray absorption film through an acrylic adhesive to prepare an AR/NIR film.

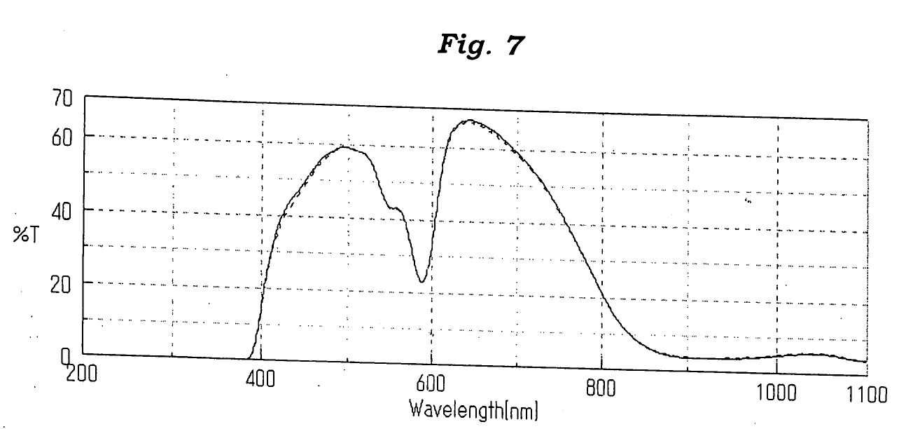

Further the resultant film was subjected to a heat resistance test at 90° C. for 1000 hours. The spectroscopic spectra before and after the heat resistance test are given in FIG. 7 wherein the solid line shows the spectrum before the heat resistance test, while the dotted line shows the spectrum after the test.

As can be clearly seen from the figure, the wave range of 850 to 1000 nm is sufficiently shielded and besides, the transmittance for visible rays is satisfactory.

Moreover, both the transmittance and the spectrum remained almost unchanged after 1000 hours of the heat resistance test. Accordingly the film has sufficient long-term heat resistance as a PDP filter.

With regard to color shade, color change after the heat resistance test at 90° C. for 1000 hours was extremely low showing 0.0009 in terms of x and 0.0008 in terms of y, thereby proving little change in the color shade.

### EXAMPLE 8

To 100 parts by weight of 1,3-dioxolane were added 20 parts by weight of norbornene resin (manufactured by JSR under the trade name “Arton”), 0.4 part by weight of the immonium compound represented by the formula (6) (manufactured by Japan Carlit Co., Ltd. under the trade name “CIR-1085”), 0.24 part by weight of the dithiol nickel compound represented by the formula (7) (manufactured by Midori Chemical Co., Ltd. under the trade name “MIR-101”), 0.025 part by weight of the dithiol nickel compound represented by the formula (4) and 0.04 part by weight of the porphyrin compound represented by the formula (10) to prepare a solution.

In the same manner as in Example 1, from the resultant resin solution, a film as a near infrared ray absorption filter was obtained.

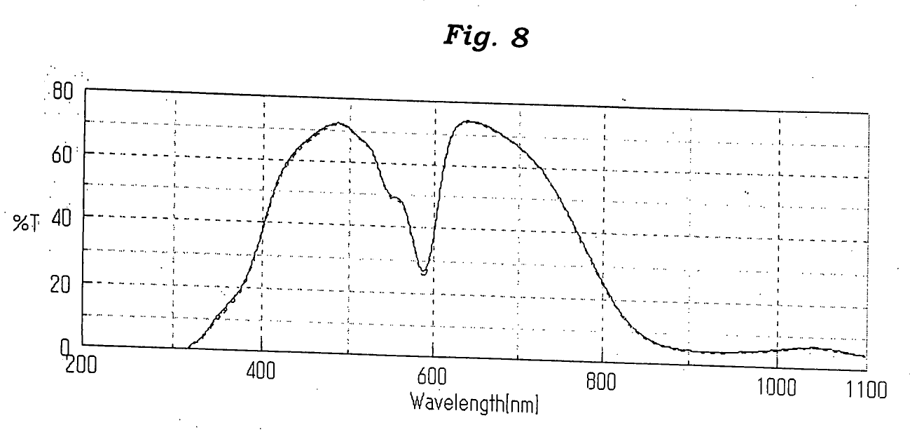

Further the resultant film was subjected to a heat resistance test at 90° C. for 1000 hours. The spectroscopic spectra before and after the heat resistance test are given in FIG. 8 wherein the solid line shows the spectrum before the heat resistance test, while the dotted line shows the spectrum after the test.

As can be clearly seen from the figure, the wave range of 850 to 1000 nm is sufficiently shielded and besides, the transmittance for visible rays is satisfactory.

Moreover, both the transmittance and the spectrum remained almost unchanged after 1000 hours of the heat resistance test. Accordingly the film has sufficient long-term heat resistance as a PDP filter.

With regard to color shade, color change after the heat resistance test at 90° C. for 1000 hours was extremely low showing 0.0009 in terms of x and 0.0008 in terms of y, thereby proving little change in the color shade.

### EXAMPLE 9

To 100 parts by weight of mixed solvent of n-butanol/ethanol at a ratio by weight of 9/1 were added 21 parts by weight of polyvinyl butyral resin (manufactured by Denki Kagaku Kogyo Co., Ltd. under the trade name “6000C”), 0.42 part by weight of the immonium compound represented by the formula (6) (manufactured by Japan Carlit Co., Ltd. under the trade name “CIR-1085”), 0.2 part by weight of the dithiol nickel compound represented by the formula (5), 0.12 part by weight of the dithiol nickel compound represented by the formula (7) (manufactured by Midori Chemical Co., Ltd. under the trade name “MIR-101”), 0.03 part by weight of the porphyrin compound represented by the formula (10) and 0.037 part by weight of a blue base coloring matter for color adjusting (manufactured by Japan Kayaku Co., Ltd. under the trade name “Kayaset Blue N”) to prepare a solution.

In the same manner as in Example 1, from the resultant resin solution, a film as a near infrared ray absorption filter was obtained.

The resultant film has a transmittance for blue rays (410 to 460 nm) as high as at least 60% compared with the Y value (53.2%), and is suited for a filter for display such as PDP.

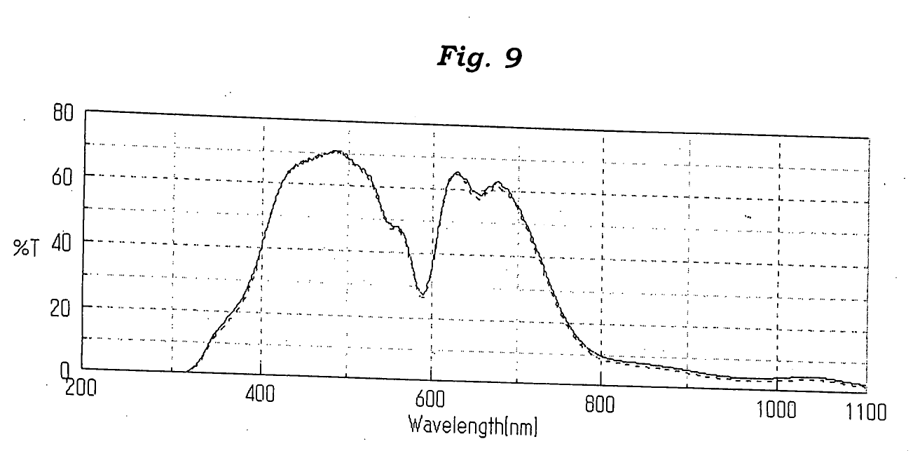

Further the resultant film was subjected to a heat resistance test at 90° C. for 1000 hours. The spectroscopic spectra before and after the heat resistance test are given in FIG. 9 wherein the solid line shows the spectrum before the heat resistance test, while the dotted line shows the spectrum after the test.

As can be clearly seen from the figure, the wave range of 850 to 1000 nm is sufficiently shielded and besides, the transmittance for visible rays is satisfactory.

Moreover, both the transmittance and the spectrum remained almost unchanged after 1000 hours of the heat resistance test. Accordingly the film has sufficient long-term heat resistance as a PDP filter.

With regard to color shade, color change after the heat resistance test at 90° C. for 1000 hours was extremely low showing 0.0009 in terms of x and 0.0010 in terms of y, thereby proving little change in the color shade.

### EXAMPLE 10

To 100 parts by weight of 1,3-dioxolane were added 21 parts by weight of polycarbonate resin (manufactured by Teijin Kasei Co., Ltd. under the trade name “Panlite L-1250Z-100”), 0.42 part by weight of the immonium compound represented by the formula (6) (manufactured by Japan Carlit Co., Ltd. under the trade name “CIR-1085”), 0.2 part by weight of the dithiol nickel compound represented by the formula (5), 0.12 part by weight of the dithiol nickel compound represented by the formula (7) (manufactured by Midori Chemical Co., Ltd. under the trade name “MIR-101”) and 0.03 part by weight of the porphyrin compound represented by the formula (10) to prepare a solution.

The resin solution thus obtained was made into a film onto a polyethylene terephthalate film imparted with UV cutting functions (manufactured by Teijin Du Pont Co., Ltd. under the trade name “HB 100 μm”) by means of a casting method by the use of a bar coater having a clearance dimension of 100 μm (manufactured by Yoshimitsu Seiki Co., Ltd. under the trade name “Doctor Blade YD-2”), and was dried at 80° C. for 3 minutes to obtain a film as a near infrared ray absorption filter.

The resultant film has a transmittance for blue rays (410 to 460 nm) as high as at least 48.9% compared with the Y value (50.0%), and is suited for a filter for display such as PDP.

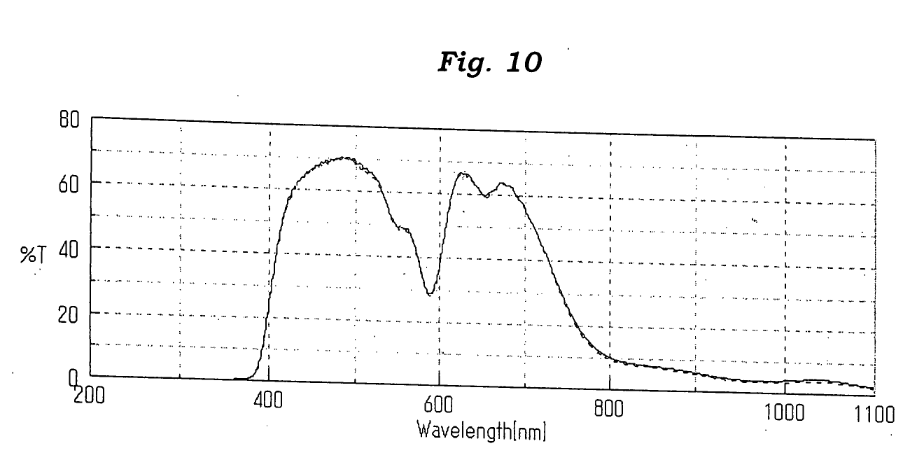

Further the resultant film was subjected to a heat resistance test at 90° C. for 1000 hours. The spectroscopic spectra before and after the heat resistance test are given in FIG. 10 wherein the solid line shows the spectrum before the heat resistance test, while the dotted line shows the spectrum after the test.

As can be clearly seen from the figure, the near infrared ray region of 850 to 1000 nm is sufficiently shielded and besides, the transmittance for visible rays are satisfactory.

Moreover, both the transmittance and the spectrum remained almost unchanged after 1000 hours of the heat resistance test. Accordingly the film has sufficient long-term heat resistance.

With regard to color shade, color change after the heat resistance test at 90° C. for 1000 hours was extremely low showing 0.0004 in terms of x and 0.0004 in terms of y, thereby proving little change in the color shade.

### EXAMPLE 11

To 100 parts by weight of 1,3-dioxolane were added 21 parts by weight of polycarbonate resin (manufactured by Teijin Kasei Co., Ltd. under the trade name “Panlite L-1250Z-100”), 0.42 part by weight of the immonium compound represented by the formula (6) (manufactured by Japan Carlit Co., Ltd. under the trade name “CIR-1085”), 0.2 part by weight of the dithiol nickel compound represented by the formula (5), 0.12 part by weight of the dithiol nickel compound represented by the formula (7) (manufactured by Midori Chemical Co., Ltd. under the trade name “MIR-101”), 0.03 part by weight of the porphyrin compound represented by the formula (10), 0.037 part by weight of a blue base coloring matter for color adjusting (manufactured by Japan Kayaku Co., Ltd. under the trade name “Kayaset Blue N”) and 0.07 part by weight of a black base coloring matter for color adjusting (manufactured by Japan Kayaku Co., Ltd. under the trade name “Kayaset Black AN”) to prepare a solution.

In the same manner as in Example 1, from the resultant resin solution, a film as a near infrared ray absorption filter was obtained.

The opposite side of the anti-reflection layer of the anti-reflection film (manufactured by Sumitomo Osaka Cement Co., Ltd. under the trade name “Clearas AR F200”) was laminated to the near infrared ray absorption layer side of the near infrared ray absorption film through a tacky adhesive containing 0.1% by weight of an antioxidant having UV cutting functions of 5% at 380 nm (manufactured by Sumitomo Seika Co., Ltd. under the trade name “EST5) to prepare an AR/NIR film.

The resultant film has a transmittance for blue rays (410 to 460 nm) as high as at least 53% compared with the Y value (53.6%), and is suited for a filter for display such as PDP.

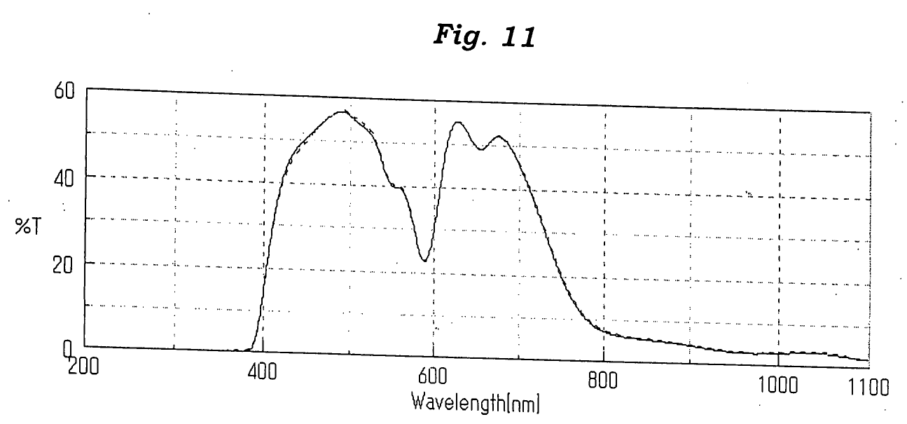

Further the resultant film was subjected to a heat resistance test at 90° C. for 1000 hours. The spectroscopic spectra before and after the heat resistance test are given in FIG. 11 wherein the solid line shows the spectrum before the resistance test, while the dotted line shows the spectrum after the test.

As can be clearly seen from the figure, the near infrared ray region of 850 to 1000 nm is sufficiently shielded and besides, the transmittance for visible rays are satisfactory.

Moreover, both the transmittance and the spectrum remained almost unchanged after 1000 hours of the heat resistance test. Accordingly the film has sufficient long-term heat resistance.

With regard to color shade, color change after the heat resistance test at 90° C. for 1000 hours was extremely low showing 0.0009 in terms of x and 0.0011 in terms of y, thereby proving little change in the color shade.

### EXAMPLE 12

The film as a near infrared ray absorption filter which had been prepared in Example 10 was irradiated with UV rays from the PET film side under the following conditions
xenon lamp (100 W/m2)
temperature: 25° C.
humidity: 60%
irradiation time: 12 hours

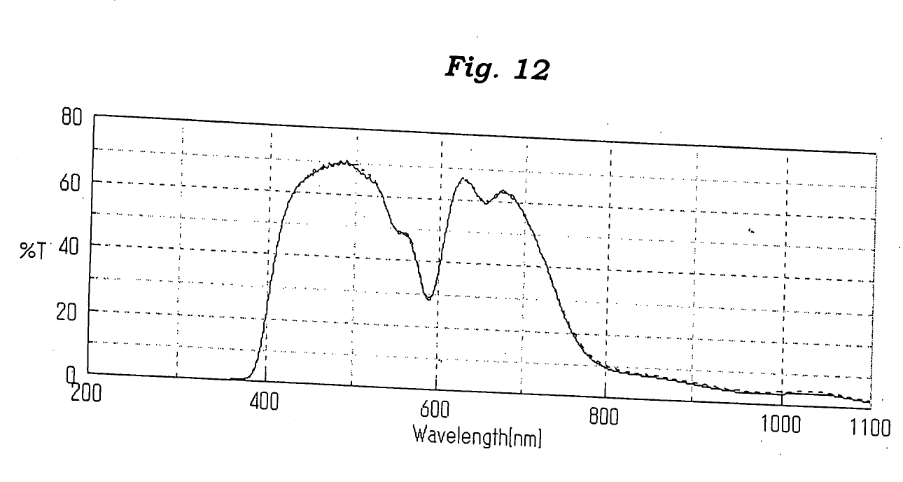

The spectroscopic spectra before and after the UV irradiation are given in FIG. 12 wherein the solid line shows the spectrum before the UV irradiation, while the dotted line shows the spectrum after the UV irradiation.

As can be clearly seen from the figure, the near infrared ray region of 850 to 1000 nm is sufficiently shielded and besides, the transmittance for visible rays are satisfactory.

Moreover, the transmittance remained almost unchanged after irradiation together with the spectrum also remaining almost unchanged. Accordingly the film has sufficient long-term heat resistance.

With regard to color shade, color change after the UV irradiation was extremely low showing 0.0011 in terms of x and 0.0015 in terms of y, thereby proving little change in the color shade.

### COMPARATIVE EXAMPLE 2

The procedure in Example 11 was repeated to prepare an AR/NIR film except that triacetylcellulose resin (manufactured by Konica Co., Ltd. under the trade name “TAC film”) was used in place of the polycarbonate resin.

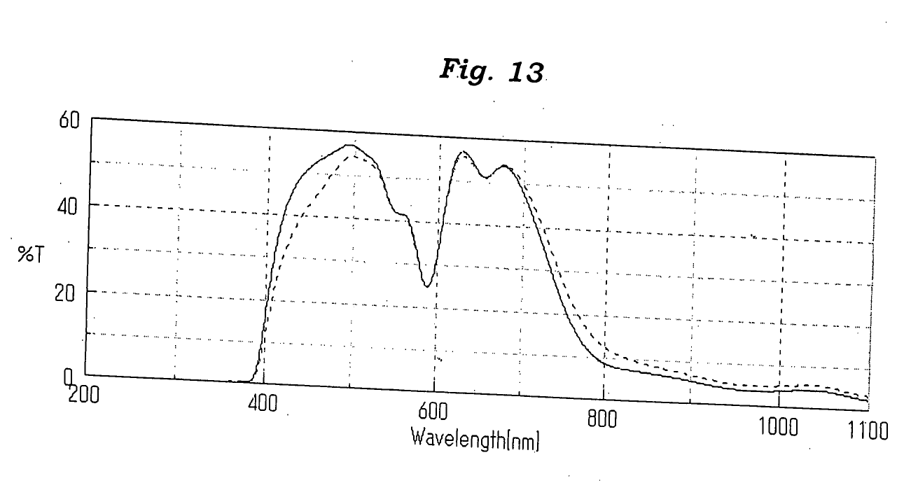

The resultant film was subjected to a heat resistance test at 90° C. for 1000 hours. The spectroscopic spectra before and after the heat resistance test are given in FIG. 13 wherein the solid line shows the spectrum before the heat resistance test, while the dotted line shows the spectrum after the test.

As can be clearly seen from the figure, the transmittance after 1000 hours of the heat resistance test markedly changed with marked change in the spectrum.

With regard to color shade, color change after the heat resistance test at 90° C. for 1000 hours was extremely high showing 0.0066 in terms of x and 0.0111 in terms of y.

### COMPARATIVE EXAMPLE 3

In the same manner as in in Example 12, the NIR film which had been prepared in the same way as in Example 10 was irradiated with UV rays from the polyethylene terephthalate PET side except that the polyethylene terephthalate film imparted with UV cutting functions was altered to an easily bondable polyethylene terephthalate film with a thickness of 100 μm (manufactured by Toyobo Co., Ltd. under the trade name “A4300”).

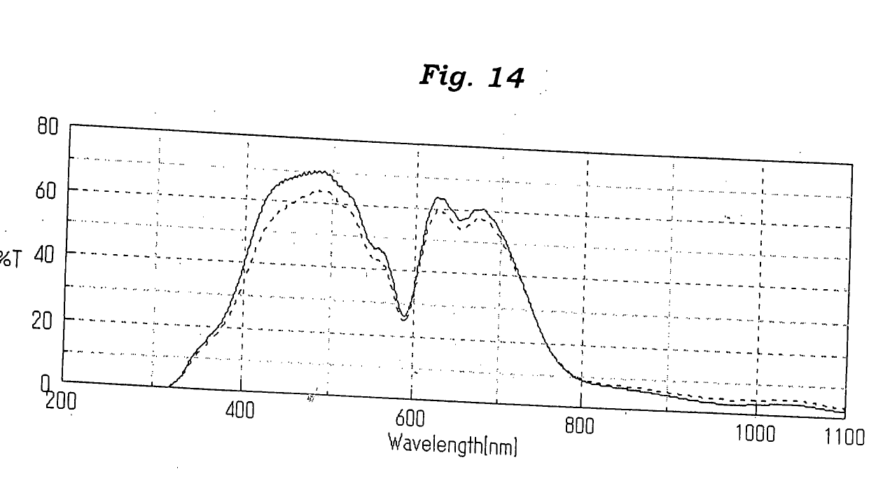

The spectroscopic spectra before and after the UV irradiation are given in FIG. 14 wherein the solid line shows the spectrum before the UV irradiation, while the dotted line shows the spectrum thereafter.

It can be confirmed from the figure that the transmittance for visible ray region markedly varied owing to irradiation, and also the NIR performance was deteriorated.

With regard to color shade, color change after the UV irradiation was extremely high showing 0.0021 in terms of x and 0.0040 in terms of y.

### INDUSTRIAL APPLICABILITY

The near infrared ray absorption composition is well suited for use as a near infrared ray absorption filter particularly for a plasma display panel, since the composition is high in visible ray transmittance, particularly blue ray transmittance and absorption efficiency for near infrared rays and besides, it is excellent in long-term durability such as heat resistance and moisture resistance. As the diimmonium compound, the use of the same free from antimony doesn't exert adverse influence on the environment.

1. A near infrared ray absorption composition which comprises a transparent resin; at least one dithiol nickel compound represented by the formula (1) 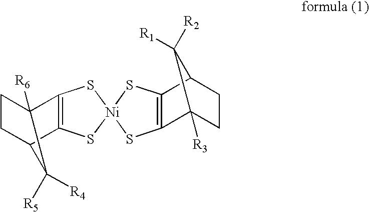
wherein R₁ to R₆ are each a hydrogen atom or an alkyl group having 1 to 8 carbon atoms, and may be the same as or different from one another; and/or at least one diimmonium compound represented by the formula (2) 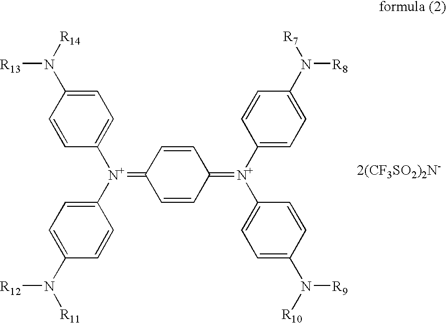
wherein R₇ to R₁₄ are each a hydrogen atom or an alkyl group having 1 to 8 carbon atoms or an aryl group having 6 to 24 carbon atoms, and may be the same as or different from one another.

2. The near infrared ray absorption composition according to claim 1, which further comprises at least one dithiol nickel compound represented by the formula (3) 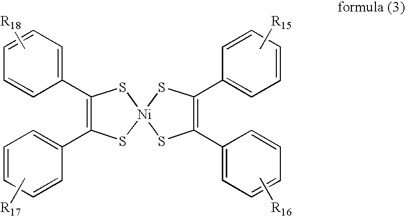
wherein R₁₅ to R₁₈ are each an alkyl group having 1 to 8 carbon atoms, an aryl group having 6 to 24 carbon atoms, an aralkyl group having 7 to 28 carbon atoms, an alkylamino group having 1 to 8 carbon atoms, an alkoxy group having 1 to 8 carbon atoms, a halogen atom or a hydrogen atom, and are same as or different from one another.

3. The near infrared ray absorption composition claim 1, which further comprises a dithiol nickel compound by the formula (4)

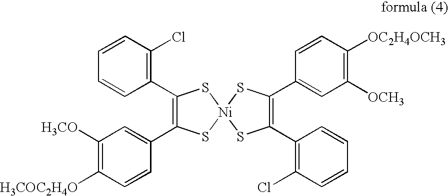

4. The near infrared ray absorption composition according to claim 1, which further comprises a coloring compound having an absorption peak in the wave range of 580 to 600 nm.

5. The near infrared ray absorption composition according to claim 1, wherein the transparent resin is any one of polycarbonate base, polyarylate base, polyester base, norbornene base, polyvinyl alcohol base, polyvinyl butyral base and methacrylic base or blended resin obtained therefrom.

6. A near infrared ray absorption filter wherein a near infrared ray absorption layer comprising the near infrared ray absorption composition as set forth in claim 1 is formed on either surface of a transparent substrate.

7. The near infrared ray absorption filter according to claim 6 wherein an anti-reflection layer is located on the opposite side of the near infrared ray absorption layer with respect to the transparent substrate.

8. The near infrared ray absorption filter according to claim 6 wherein the transparent substrate is imparted with ultraviolet ray cutting functions.

9. The near infrared ray absorption filter according to claim 6 wherein the near infrared ray absorption layer is imparted with ultraviolet ray cutting functions.

10. The near infrared ray absorption filter according to claim 7 wherein an adhesive agent layer which comprises an adhesive agent containing an antioxidant in an amount of 0.001 to 20% by weight is formed on the near infrared ray absorption layer.

11. The near infrared ray absorption filter according to claim 6 wherein the near infrared ray absorption layer is formed by a solution casting method.

12. The near infrared ray absorption filter according to claim 6 which is used for cathode ray tube, liquid crystal display, electroluminescence display, light emitting diode (LED) display, feed emission display (FED) or plasma display.

13. The near infrared ray absorption composition according to claim 2, which further comprises a dithiol nickel compound represented by the formula (4)

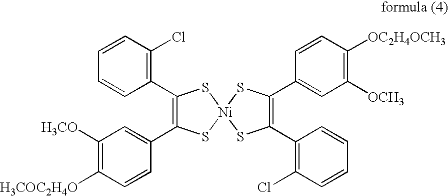

14. A near infrared ray absorption filter wherein a near infrared ray absorption layer comprising the near infrared ray absorption composition as set forth in claim 13 is formed on either surface of a transparent substrate.

15. A near infrared ray absorption filter wherein a near infrared ray absorption layer comprising the near infrared ray absorption composition as set forth in claim 3 is formed on either surface of a transparent substrate.

16. A near infrared ray absorption filter wherein a near infrared ray absorption layer comprising the near infrared ray absorption composition as set forth in claim 2 is formed on either surface of a transparent substrate.

17. The near infrared ray absorption filter according to claim 7 wherein the transparent substrate is imparted with ultraviolet ray cutting functions.

18. The near infrared ray absorption filter according to claim 7 wherein the near infrared ray absorption layer is imparted with ultraviolet ray cutting functions.
